(19) United States
(12) Patent Application Publication
(10) Pub. No.: US 2017/0012991 A1
(43) Pub. Date: Jan. 12, 2017

(54) METHOD AND SYSTEM FOR WIRELESSLY COMMUNICATING WITH PROCESS MACHINERY USING A REMOTE ELECTRONIC DEVICE

(71) Applicant: Honeywell International Inc., Morristown, NJ (US)

(72) Inventors: Sumanth Gogada, Telangana (IN); Manish Mahaling Kumbhar, Telangana (IN)

(21) Appl. No.: 14/794,727

(22) Filed: Jul. 8, 2015

(51) Int. Cl. H04L 29/06; H04W 12/06

(52) U.S. Cl. CPC H04L 63/105; H04W 12/06; H04W 88/02

(57) ABSTRACT

A method implemented using a server includes receiving a credential to access one or more transmitters from a user equipment (UE). The method also includes transmitting a signal to the UE granting access to the one or more transmitters as a function of the credential. The method further includes receiving a command from the UE to access one or more parameters associated with the one or more transmitters. In addition, the method includes communicating to the UE one or more parameter outputs as a function of the command.

### TECHNICAL FIELD

This disclosure relates generally to industrial process control and automation systems. More specifically, this disclosure relates to a method and system for wirelessly monitoring and communicating with process machinery using a remote electronic device.

### BACKGROUND

Industrial process control and automation systems, including distributed control systems (DCSs), are often used to automate large and complex industrial processes. These types of systems routinely include sensors, actuators, and controllers. The controllers typically receive measurements from the sensors and generate control signals for the actuators. Transmitters are used with each of the sensors and actuators to communicate with the controllers. Parameters of the transmitters are configured via the DCS or through a display and keyboard interface at the transmitters.

### SUMMARY

This disclosure provides a method and system a method and system for wirelessly monitoring and communicating with process machinery using a remote electronic device.

In a first embodiment, a method implemented using a server includes receiving a credential to access one or more transmitters from a user equipment (UE). The method also includes transmitting a signal to the UE granting access to the one or more transmitters as a function of the credential. The method further includes receiving a command from the UE to access one or more parameters associated with the one or more transmitters. In addition, the method includes communicating to the UE one or more parameter outputs as a function of the command.

In a second embodiment, an apparatus of a server includes at least one processing device configured to receive a credential to access one or more transmitters from a user equipment (UE). The at least one processing device is also configured to transmit a signal to the UE granting access to the one or more transmitters as a function of the credential. The at least one processing device is further configured to receive a command from the UE to access one or more parameters associated with the one or more transmitters. In addition, the at least one processing device is configured to communicate to the UE one or more parameter outputs as a function of the command.

In a third embodiment, an apparatus of a user equipment (UE) includes at least one processing device configured to transmit to a server a credential to access one or more transmitters. The at least one processing device is also configured to receive a signal from the server granting access to the one or more transmitters as a function of the credential. The at least one processing device is further configured to transmit a command to the server to access one or more parameters associated with the one or more transmitters. In addition, the at least one processing device is configured to receive from the server one or more parameter outputs as a function of the command.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1 and 2 illustrate example industrial process control and automation systems according to this disclosure;

FIG. 3 illustrates an example user equipment (UE) according to this disclosure;

FIG. 4 illustrates an example server according to this disclosure;

FIG. 5 illustrates an example method implemented by a server according to this disclosure; and

FIG. 6 illustrates an example method implemented by a UE according to this disclosure.

### DETAILED DESCRIPTION

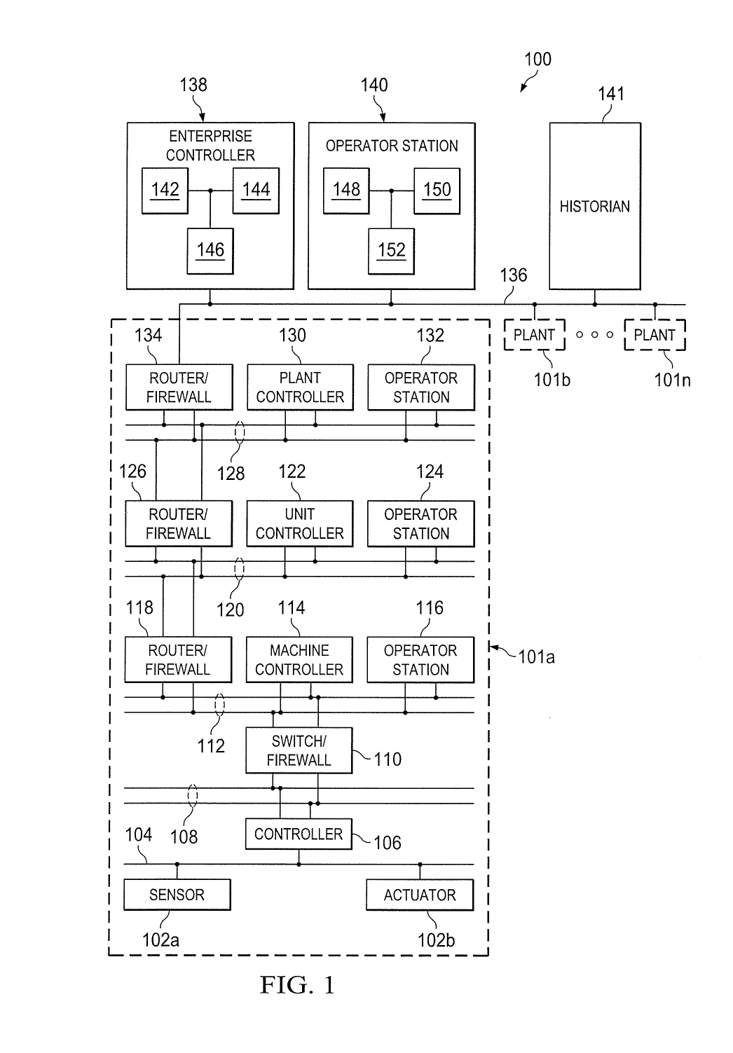

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a multivariable controller, such as an EXPERION C300 controller by HONEYWELL INTERNATIONAL INC. As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers could include one or more processing devices 142 and one or more memories 144 for storing instructions and data used, generated, or collected by the processing device(s) 142. Each of the controllers could also include at least one network interface 146, such as one or more Ethernet interfaces or wireless transceivers. Also, each of the operator stations could include one or more processing devices 148 and one or more memories 150 for storing instructions and data used, generated, or collected by the processing device(s) 148. Each of the operator stations could also include at least one network interface 152, such as one or more Ethernet interfaces or wireless transceivers.

In some embodiments, various actuators and sensors of the system 100 in FIG. 1 include transmitters that monitor and communicate parameters associated with an enterprise controller (e.g., the enterprise-level controller 138) or an operator station (e.g., the operator station 140). The parameters are associated with actuators or sensors. The transmitters include user interfaces (UIs) that allow for viewing parameters at the transmitter and providing inputs to manipulate parameters associated with the actuators or sensors of the transmitter. These transmitters can be located at difficult to reach or hazardous locations. The UIs located at or near the transmitters can also be difficult to configure, read, and access due to environmental factors.

Although FIG. 1 illustrates one example of an industrial process control and automation system 100, various changes may be made to FIG. 1. For example, a control system could include any number of sensors, actuators, controllers, servers, operator stations, networks, and the like. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, process control systems are highly configurable and can be configured in any suitable manner according to particular needs. In addition, the functionality of the example environment of FIG. 1 can be used in any other suitable device or system.

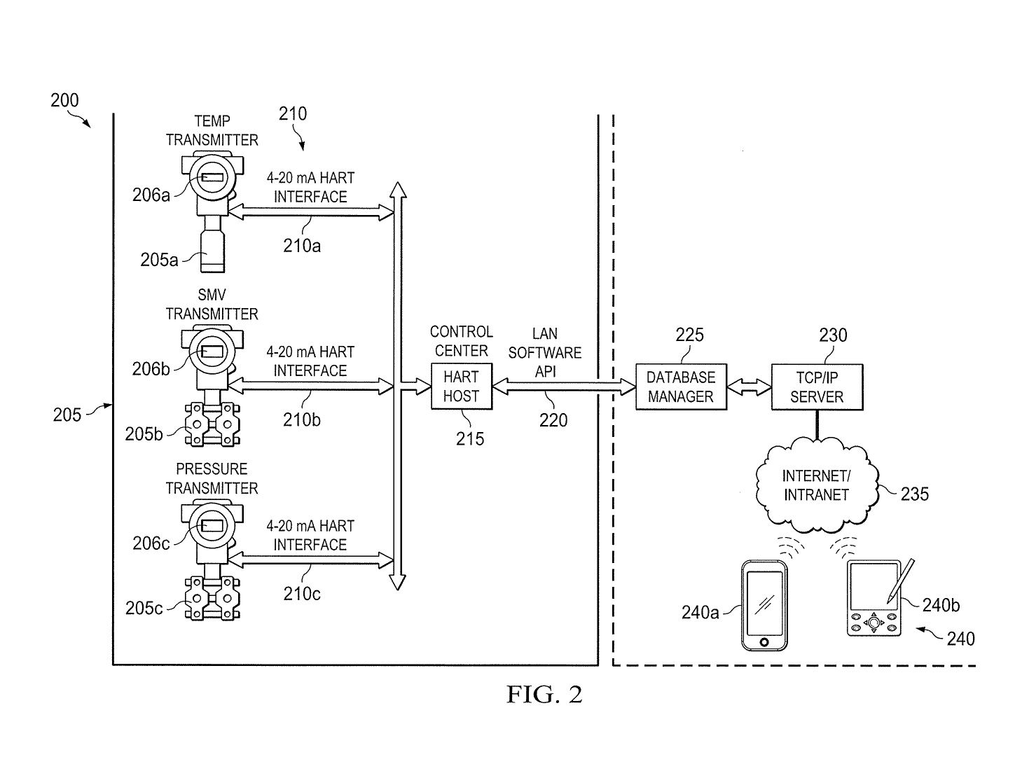

FIG. 2 illustrates an example industrial process control and automation system 200 according to this disclosure. The industrial process control and automation system 200 could denote all or part of the system 100 of FIG. 1. As shown in FIG. 2, the system 200 includes one or more transmitters 205, one or more interface connections 210, a control center 215, a software application programming interface (API) 220, a database manager 225, a server 230, and one or more user equipements (UEs) 240.

The one or more transmitters 205 monitor and communicate parameters with an enterprise controller (e.g., the enterprise-level controller 138) or an operator station (e.g., the operator station 140). The parameters may be associated with actuators (e.g., the actuators 102b) or sensors (e.g., the sensors 102a). For example, the temperature transmitter 205a monitors and communicates parameters associated with a temperature sensor. The small multivariable (SMV) transmitter 205b monitors and communicates parameters associated with one or more actuators and actuators. The pressure transmitter 205c monitors and communicates parameters associated with a pressure sensor. The transmitters 205a, 205b, 205c includes UIs 206a, 206b, and 206c, respectively, to receive input parameters and display parameters associated with actuators or sensors.

Each of the one or more transmitters 205 is communicatively linked to a control center 215 via one or more interface connections 210. Each of the one or more interface connections 210 is configured to permit communication of actuator or sensor parameters and commands between a transmitter 205 and a control center 215. For example, transmitter 205a communicates with the control center 215 via interface connection 210a, transmitter 205b communicates with the control center 215 via interface connection 210b, and transmitter 205c communicates with the control center 215 via interface connection 210c. The one or more interface connections 210 can be a 4-20 mA HART interface connection. The control center 215 can be a HART host control center.

The control center 215 also receives commands and requests for parameter information from an electronic device, as disclosed herein, and transmits those commands and requests to appropriate transmitters. For example, the control center 215 receives a request via interface connection 210a for a temperature measurement from a sensor associated with transmitter 205a. The transmitter 205a obtains the temperature measurement from the sensors and transmits the temperature measurement via the interface connection 210a to the control center 215.

The control center 215 is communicatively linked to a database manager 225 and a server 230 via the database manager 225. The control center 215 communicates to the database manager 225 via a software API 220. The software API 220 can be a local area network (LAN). The database manager 225 permits interaction with an electronic device, other applications, and the database itself to capture and analyze data. The database manager 225 is configured to define, create, query, update, and control the administration of databases. The database manager 225 captures process data (such as parameters associated with actuators 102b or sensors 102a) and stores the process data for access by the server 230 and the UE 240.

The server 230 is communicatively linked to an internet or cloud computing system 235 (hereafter “internet 235”). The server 230 provides a communication link between the database manager 225, the control center 215, the one or more transmitters 205, and one or more UEs 240 via the internet 235. The server 230 receives commands and requests from the one or more UEs 240 via the internet 235 and transmits the commands or request as discussed herein to one or more appropriate transmitters 205. The server 230 also receives parameters from the one or more appropriate transmitters 205 (such as the one or more transmitters 205 receiving the commands and requests from the server 230) and transmits those parameters via the internet 235 to the one or more UEs 240. The UEs 240 can include a mobile phone 240a, person digital assistant 240b, and the like.

In an embodiment, the server 230 also validates a UE 240 before communicating received commands between the UE 240 and the one or more transmitters 205. For example, a UE 240 can transmit one or more credentials (such as a user name and password, international mobile station equipment identifier (IMEI), or the like) to the server 230 for validation. The server 230 can store one or more validated credentials so that when the server receives one of the validated credentials from a particular UE 240, the server 230 validates the UE 240 sending the credentials and permits the UE 240 to communicate with one or more transmitters 205 through the server 230.

In an embodiment, when a server 230 receives one or more credentials from a UE 240, the server 230 determines the level of access available to the UE 240 providing the credentials. The level of access can limit the UE 240 to communicating particular command types to the transmitters 205. For example, when the server 230 receives a first credential from a UE 240, the server 230 can determine that the UE 240 is only permitted to provide parameter monitoring commands to transmitters 205 to monitor parameters of one or more actuators or sensors while prohibiting parameter changing commands to transmitters 205 to change parameters in an industrial system. Conversely, when the server 230 receives a second, different credential from a UE 240, the server 230 can determine that the UE is permitted to provide parameter monitoring commands to transmitters 205 to monitor parameters of one or more actuators or sensors as well as provide parameter changing commands to transmitters 205 to change parameters in an industrial system.

The level of access can also limit the UE 240 to communicating with select transmitters 205. For example, when the server 230 receives a first credential from a UE 240, the server 230 can determine that the UE 240 is only permitted to provide commands to transmitters 205a and 205b, but not transmitter 205c. Conversely, when the server 230 receives a second, different credential from a UE 240, the server 230 can determine that the UE is permitted to provide commands to transmitters 205a, 205b, and 205c.

Although FIG. 2 illustrates one example of an industrial process control and automation system 200, various changes may be made to FIG. 2. For example, a control system could include any number of transmitters, controllers, control centers, data managers, servers, networks, electronic devices, and the like. Also, the makeup and arrangement of the system 200 in FIG. 2 is for illustration only. Components could be added, omitted, combined, or placed in any other suitable configuration according to particular needs. Further, particular functions have been described as being performed by particular components of the system 200. This is for illustration only. In general, process control systems are highly configurable and can be configured in any suitable manner according to particular needs. In addition, FIG. 2 illustrates an example environment for wirelessly monitoring and communicating with process machinery using a remote electronic device. This functionality can be used in any other suitable device or system.

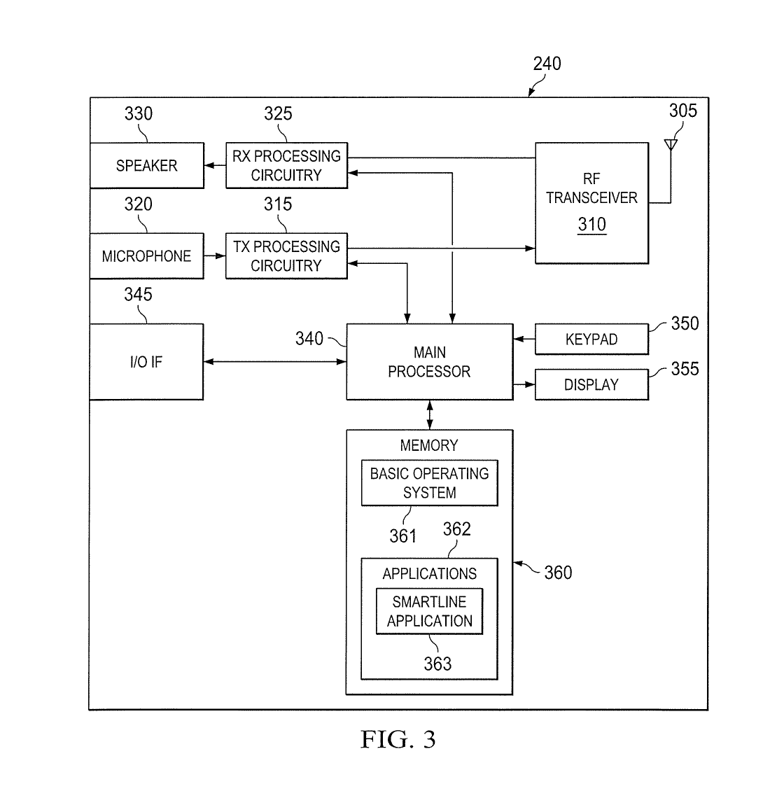

FIG. 3 illustrates an example configuration of a UE 240 according to this disclosure. The embodiment of the UE 240 illustrated in FIG. 3 is for illustration only, and the one or more UEs 240 of FIG. 2 could have the same or similar configuration. However, UEs come in a wide variety of configurations, and FIG. 3 does not limit the scope of this disclosure to any particular implementation of a UE.

As shown in FIG. 3, the UE 240 includes an antenna 305, a radio frequency (RF) transceiver 310, transmit (TX) processing circuitry 315, a microphone 320, and receive (RX) processing circuitry 325. The UE 240 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an eNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 240. For example, the main processor 340 could control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for remotely monitoring and communicating with transmitters 205 of process machinery (such as sensor and actuators) via the internet 235 and the server 230. The main processor 340 is also capable of executing processes and programs resident in the memory 360 such as wirelessly sending credentials to the server 230 via the internet for UE validation and configuring transmitters in a processing system. The main processor 340 can move data into or out of the memory 360 as required by an executing process. In some embodiments, the main processor 340 is configured to execute the applications 362 based on the OS program 361 or in response to signals received from eNBs or an operator.

In some embodiments, the main processor 340 is configured to execute a SMARTLINE® application 363. The SMARTLINE® application 363 is configured to permit the UE 240 to communicate with transmitters 205 of process machinery (such as sensor and actuators) via the server 230 as well as send credentials to the server 230 for UE validation as discussed herein. The SMARTLINE® application 363 can be downloaded from a server to any mobile communication device including smart phones, tablets, and the like.

The main processor 340 is also coupled to the I/O interface 345, which provides the UE 240 with the ability to connect to other devices such as laptop computers and handheld computers. The I/O interface 345 is the communication path between these accessories and the main processor 340.

The main processor 340 is also coupled to the keypad 350 and the display unit 355. The operator of the UE 240 can use the keypad 350 to enter data into the UE 240. The display 355 may be a liquid crystal display or other display capable of rendering text and/or at least limited graphics, such as from web sites.

The memory 360 is coupled to the main processor 340. Part of the memory 360 could include a random access memory (RAM), and another part of the memory 360 could include a Flash memory or other read-only memory (ROM).

In an embodiment, the UE 240 comprises an apparatus including at least one processing device such as main processor 340. The processing device receives executable instructions from the memory 360. The executable instructions include the instructions from the SMARTLINE® application 363 stored in the memory 360. The processing device using the executable instructions is configured to transmit to a server a credential to access one or more transmitters. The processing device using the executable instructions is configured to receive a signal from the server granting access to the one or more transmitters as a function of the credential. The processing device using the executable instructions is configured to transmit a command to the server to access one or more parameters associated with the one or more transmitters. The processing device using the executable instructions is configured to receive from the server one or more parameter outputs as a function of the command.

Although FIG. 3 illustrates one example configuration of a UE 240, various changes may be made to FIG. 3. For example, various components in FIG. 3 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 3 illustrates the UE 240 configured as a mobile telephone or smartphone, UEs could be configured to operate as other types of mobile or stationary devices.

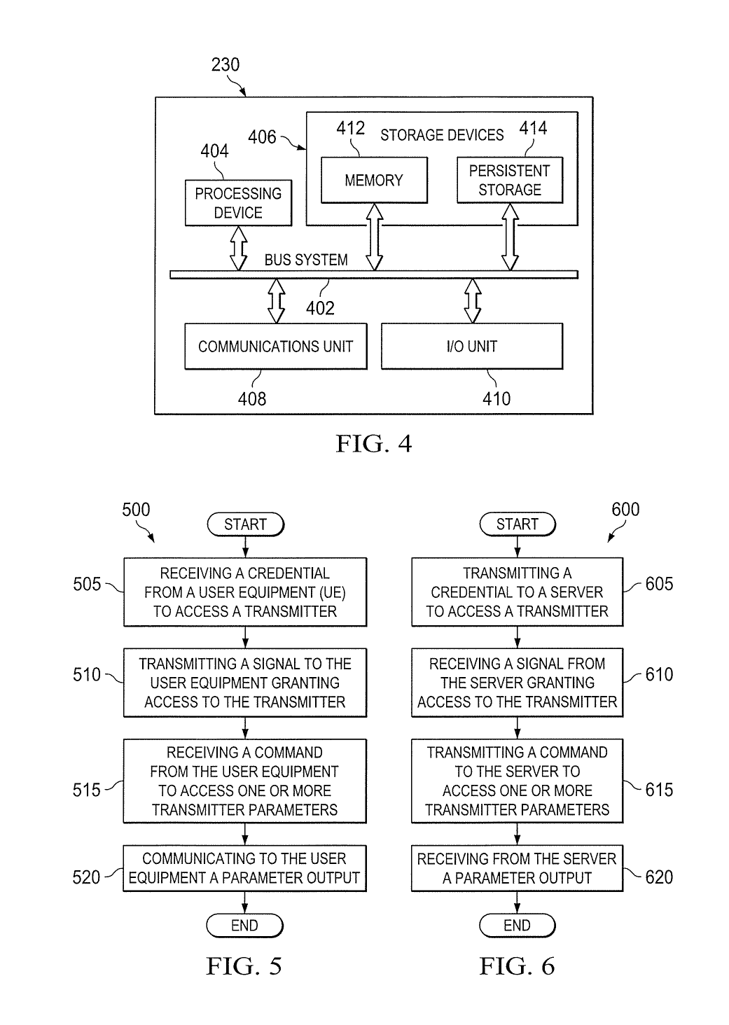

FIG. 4 illustrates an example configuration of a server 230 according to this disclosure. The server 230 communicates commands and parameters between UEs 240 and one or more transmitters 205 associated with process machinery (such as actuators and sensors) and validate credentials transmitted from a UE 240 as discussed herein.

As shown in FIG. 4, the server 230 includes a bus system 402, which supports communication between at least one processing device 404, at least one storage device 406, at least one communications unit 408, and at least one input/output (I/O) unit 410. The processing device 404 executes instructions that may be loaded into a memory 412. The processing device 404 may include any suitable number(s) and type(s) of processors or other devices in any suitable arrangement. Example types of processing devices 404 include microprocessors, microcontrollers, digital signal processors, field programmable gate arrays, application specific integrated circuits, and discrete circuitry.

The memory 412 and a persistent storage 414 are examples of storage devices 406, which represent any structure(s) capable of storing and facilitating retrieval of information (such as data, program code, and/or other suitable information on a temporary or permanent basis). The memory 412 may represent a random access memory or any other suitable volatile or non-volatile storage device(s). The persistent storage 414 may contain one or more components or devices supporting longer-term storage of data, such as a ready only memory, hard drive, Flash memory, or optical disc.

The communications unit 408 supports communications with other systems or devices. For example, the communications unit 408 could include a network interface card that facilitates communications over at least one Ethernet network. The communications unit 408 could also include a wireless transceiver facilitating communications over at least one wireless network. The communications unit 408 may support communications through any suitable physical or wireless communication link(s).

The I/O unit 410 allows for input and output of data. For example, the I/O unit 410 may provide a connection for user input through a keyboard, mouse, keypad, touchscreen, or other suitable input device. The I/O unit 410 may also send output to a display, printer, or other suitable output device.

Although FIG. 4 illustrates one example configuration of a server 230 that communicates commands and parameters between UEs 240 and one or more transmitters 205 associated with process machinery (such as actuators and sensors) and validates credentials transmitted from a UE 240, various changes may be made to FIG. 4. For example, various components in FIG. 4 could be combined, further subdivided, or omitted, and additional components could be added according to particular needs. Also, computing devices can come in a wide variety of configurations, and FIG. 4 does not limit this disclosure to any particular configuration of computing device.

FIG. 5 illustrates an example method 500 implemented using a server according to this disclosure. For ease of explanation, the method 500 is described as being performed by the server 230 in the system 200 of FIG. 2. However, the method 500 could be used with any suitable device or system.

At step 505, a server 230 receives a credential to access one or more transmitters 205 from a user equipment (UE) 240. The credential can include at least one of a user name and password or an international mobile station equipment identifier (IMEI) of a wireless handset, or the like. The server 230 can validate the credential by comparing the received credential with a database storing one or more valid credentials. If the received credential matches a valid credential, the server 230 can grant access to one or more transmitters 205. When the credential received by the server 230 from the UE 240 does not match a valid credential, the server 230 can deny access to the one or more transmitters 205.

At step 510, the server 230 transmits a signal to the UE 240 granting access to the one or more transmitters 205 as a function of the credential. For example, the server 230 transmits a signal to the UE 240 granting access to the one or more transmitters 205 when the received credential is validated. The signal granting access to the one or more transmitters comprises a level of access provided to the UE 240. The level of access provided to the UE 240 can include a level of access that limits access by the UE 240 to select transmitters of the one or more transmitters 205. The level of access provided to the UE 240 can also include a level of access that limits the UE 240 to select command types of one or more command types that the UE 240 is permitted to transmit to the one or more transmitters 205. In an embodiment, the server 230 transmits a signal to the UE 240 denying access to the one or more transmitters 205 when the received credential does not match a stored validated credential.

At step 515, the server 230 receives a command from the UE 240 to access one or more parameters associated with the one or more transmitters 205. The server 230 can also receive a command from the UE 240 to configure the one or more transmitters 205. The command to access the one or more parameters instructs the one or more transmitters 205 to transmit the one or more parameters sensed by one or more sensors 102a to the server 230. The command to access the one or more parameters instructs the one or more transmitters 205 to initiate a parameter change of the one or more parameters. Initiating the parameter change of the one or more parameters includes actuating one or more actuators 102b. At step 520, the server 230 communicates to the UE 240 one or more parameter outputs as a function of the command. The one or more parameter outputs includes at least one of a parameter value sensed by one or more sensors 102a or an actuation change amount of one or more actuators 102b.

Although FIG. 5 illustrates one example of a method 500, various changes may be made to FIG. 5. For example, while shown as a series of steps, various steps shown in FIG. 5 could overlap, occur in parallel, occur in a different order, or occur multiple times. Moreover, some steps could be combined or removed and additional steps could be added according to particular needs.

FIG. 6 illustrates an example method 600 implemented using a user equipment (UE) according to this disclosure. For ease of explanation, the method 600 is described as being performed by the UE 240 in the system 200 of FIG. 2. However, the method 600 could be used with any suitable device or system.

At step 605, a UE 240 transmits to a server 230 a credential to access one or more transmitters 205. The credential can include at least one of a user name and password or an international mobile station equipment identifier (IMEI) of a wireless handset, or the like. The credential can be received by the UE 240 through a user interface provided on the display 355 of the UE 240 and subsequently can be transmitted to the server 230 as described herein. The server 230 can validate the credential by comparing the received credential with database storing one or more valid credentials. If the received credential matches a valid credential, the server 230 can grant access to one or more transmitters 205. When the credential received by the server 230 from the UE 240 does not match a valid credential, the server 230 can deny access to the one or more transmitters 205.

At step 610, the UE 240 receives a signal from the server 230 granting access to the one or more transmitters 205 as a function of the credential. For example, the server 230 transmits a signal to the UE 240 granting access to the one or more transmitters 205 when the received credential has been validated. The signal granting access to the one or more transmitters comprises a level of access provided to the UE 240. The level of access provided to the UE 240 can include a level of access that limits access by the UE 240 to select transmitters of the one or more transmitters 205. The level of access provided to the UE 240 can also include a level of access that limits the UE 240 to select command types of one or more command types that the UE 240 is permitted to transmit to the one or more transmitters 205. In an embodiment, the server 230 transmits a signal to the UE 240 denying access to the one or more transmitters 205 when the received credential does not match a stored validated credential.

At step 615, the UE 240 transmits a command to the server 230 to access one or more parameters associated with the one or more transmitters 205. The UE 240 can also transmit a command to the server 230 to configure the one or more transmitters 205. The command to access the one or more parameters instructs the one or more transmitters 205 to transmit the one or more parameters sensed by one or more sensors 102a to the server 230. The command to access the one or more parameters instructs the one or more transmitters 205 to initiate a parameter change of the one or more parameters. Initiating the parameter change of the one or more parameters includes actuating one or more actuators 102b. At step 620, the UE 240 receives from the server one or more parameter outputs as a function of the command. The one or more parameter outputs includes at least one of a parameter value sensed by one or more sensors 102a or an actuation change amount of one or more actuators 102b.

Although FIG. 6 illustrates one example of a method 600, various changes may be made to FIG. 6. For example, while shown as a series of steps, various steps shown in FIG. 6 could overlap, occur in parallel, occur in a different order, or occur multiple times. Moreover, some steps could be combined or removed and additional steps could be added according to particular needs.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method implemented using a server, the method comprising:
receiving a credential to access one or more transmitters from a user equipment (UE);
transmitting a signal to the UE granting access to the one or more transmitters as a function of the credential;
receiving a command from the UE to access one or more parameters associated with the one or more transmitters; and
communicating to the UE one or more parameter outputs as a function of the command.

2. The method of claim 1, wherein the signal granting access to the one or more transmitters comprises a level of access provided to the UE.

3. The method of claim 2, wherein the level of access provided to the UE comprises at least one of:
a level of access that limits access by the UE to select at least one transmitter of the one or more transmitters; or a level of access that limits the UE to select one or more command types that the UE is permitted to transmit to the one or more transmitters.

4. The method of claim 1, wherein the command to access the one or more parameters instructs the one or more transmitters to transmit the one or more parameters sensed by one or more sensors to the server.

5. The method of claim 1, wherein the command to access the one or more parameters instructs the one or more transmitters to initiate a parameter change of the one or more parameters.

6. The method of claim 5, wherein initiating the parameter change of the one or more parameters comprises actuating one or more actuators.

7. The method of claim 1, wherein the one or more parameter outputs comprise at least one of a parameter value sensed by one or more sensors or an actuation change amount of one or more actuators.

8. The method of claim 1, wherein the credential comprises at least one of a user name and password or an international mobile station equipment identifier (IMEI) of a wireless handset.

9. An apparatus of a server, the apparatus comprising:
at least one processing device configured to:
receive a credential to access one or more transmitters from a user equipment (UE);
transmit a signal to the UE granting access to the one or more transmitters as a function of the credential;
receive a command from the UE to access one or more parameters associated with the one or more transmitters; and
communicate to the UE one or more parameter outputs as a function of the command.

10. The apparatus of claim 9, wherein the signal granting access to the one or more transmitters comprises a level of access provided to the UE.

11. The apparatus of claim 10, wherein the level of access provided to the UE comprises at least one of:
a level of access that limits access by the UE to select at least one transmitter of the one or more transmitters; or a level of access that limits the UE to select one or more command types that the UE is permitted to transmit to the one or more transmitters.

12. The apparatus of claim 9, wherein the command to access the one or more parameters instructs the one or more transmitters to transmit the one or more parameters sensed by one or more sensors to the server.

13. The apparatus of claim 9, wherein the command to access the one or more parameters instructs the one or more transmitters to initiate a parameter change of the one or more parameters.

14. The apparatus of claim 13, wherein initiating the parameter change of the one or more parameters comprises actuating one or more actuators.

15. The apparatus of claim 9, wherein the one or more parameter outputs comprise at least one of a parameter value sensed by one or more sensors or an actuation change amount of one or more actuators.

16. The apparatus of claim 9, wherein the credential comprises at least one of a user name and password or an international mobile station equipment identifier (IMEI) of a wireless handset.

17. An apparatus of a user equipment (UE), the apparatus comprising:
at least one processing device configured to:
transmit to a server a credential to access one or more transmitters;
receive a signal from the server granting access to the one or more transmitters as a function of the credential;
transmit a command to the server to access one or more parameters associated with the one or more transmitters; and
receive from the server one or more parameter outputs as a function of the command.

18. The apparatus of claim 17, wherein the credential comprises at least one of a user name and password or an international mobile station equipment identifier (IMEI) of a wireless handset.

19. The apparatus of claim 17, wherein the signal granting access to the one or more transmitters comprises a level of access provided to the UE.

20. The apparatus of claim 17, wherein the one or more parameter outputs comprise at least one of a parameter value sensed by one or more sensors or an actuation change amount of one or more actuators.
